(19) United States
(12) Patent Application Publication
(10) Pub. No.: US 2008/0004143 A1
(43) Pub. Date: Jan. 3, 2008

(54) Bicycle sprocket assembly

(75) Inventors: Takanori Kanehisa, Osaka (JP); Yoshiaki Ando, Osaka (JP); Kenji Kamada, Osaka (JP)

Correspondence Address: GLOBAL IP COUNSELORS, LLP, 1233 20TH STREET, NW, SUITE 700, WASHINGTON, DC, 20036-2680, US

(73) Assignee: Shimano Inc., Sakai (JP)

(21) Appl. No.: 11/454,115

(22) Filed: Jun. 16, 2006

(51) Int. Cl. F16H 55/30

(52) U.S. Cl. 474/160

(57) ABSTRACT

A bicycle sprocket assembly includes first, second and third sprockets. A first mounting portion of the first sprocket is directly connected to a second mounting portion of the second sprocket by first fasteners at circumferentially spaced apart locations. The first sprocket is supported on the second sprocket by the first fasteners and axially spaced from the second sprocket by the first fasteners. A second mounting portion of the second sprocket is directly connected to a third mounting portion of the third sprocket by second fasteners. The second sprocket is supported on the third sprocket by the second fasteners and axially spaced from the third sprocket by the second fasteners. First and second radially innermost ends of the first and second sprockets are radially spaced from and free from contact with a freewheel when the bicycle sprocket assembly is mounted to the freewheel.

### BACKGROUND OF THE INVENTION

1. Field of the Invention

This invention generally relates to a bicycle sprocket assembly. More specifically, the present invention relates to a bicycle sprocket assembly that is configured to reduce the weight of a bicycle hub.

2. Background Information

Bicycling is becoming an increasingly more popular form of recreation as well as a means of transportation. Moreover, bicycling has become a very popular competitive sport for both amateurs and professionals. Whether the bicycle is used for recreation, transportation or competition, the bicycle industry is constantly improving the various components of the bicycle to meet the demands of the riders.

In recent years, as the number of speeds available in bicycle transmissions has increased, the number of sprockets installed on the rear-wheel sprocket assembly of such bicycles has increased six sprocket wheels or more. As a result, the weight of the bicycle has increased. Thus, there is a desire to reduce the weight of the bicycle. In other words, in pursuit of faster running speed, it is desirable to reduce the weight of all kinds of parts of the bicycle.

In order to reduce the weight of a multiple sprocket assembly, a spider (sprocket support), which supports a plurality of ring-shaped sprocket wheels, has been proposed. By using a spider, a light metal such as aluminum, etc., is generally used for the spider, while various types of steel materials or titanium are used for the sprockets to provide adequate strength. One example of a multiple sprocket assembly that uses a spider is disclosed in U.S. Pat. No. 6,102,821 (assigned to Shimano Inc.). In this patent, two spiders are used with each spider supporting two sprockets. Each spider has a boss part and a plurality of support arms which extend radially outward from the outer circumferential surfaces of the boss part in directions perpendicular to the axis of the boss part. The sprockets are attached to mounting surfaces on opposite side surfaces of each of the support arms. Accordingly, this construction is greatly improved in terms of weight reduction.

In view of the above, it will be apparent to those skilled in the art from this disclosure that there exists a need for an improved bicycle sprocket assembly. This invention addresses this need in the art as well as other needs, which will become apparent to those skilled in the art from this disclosure.

### SUMMARY OF THE INVENTION

One object of the present invention is to provide a bicycle sprocket assembly with additional sprockets with minimal added weight to the overall bicycle sprocket assembly.

The foregoing objects can basically be attained by providing a bicycle sprocket assembly with a first sprocket, a second sprocket and a third sprocket. The first sprocket includes a first mounting portion with a first radially innermost end, and a first chain engaging portion with a plurality of first teeth. The second sprocket includes a second mounting portion with a second radially innermost end, and a second chain engaging portion with a plurality of second teeth. The first mounting portion of the first sprocket is directly connected to the second mounting portion of the second sprocket by a plurality of individual first fasteners at a plurality of circumferentially spaced apart locations such that the first sprocket is supported on the second sprocket by the first fasteners and axially spaced from the second sprocket by the first fasteners. The third sprocket includes a third mounting portion with a third radially innermost end, and a third chain engaging portion with a plurality of third teeth. The second mounting portion of the second sprocket is directly connected to the third mounting portion of the third sprocket by a plurality of individual second fasteners such that the second sprocket is supported on the third sprocket by the second fasteners and axially spaced from the third sprocket by the second fasteners. Further, the third radially innermost end of the third sprocket includes a freewheel mounting structure configured to be mounted to a freewheel. The first and second radially innermost ends of the first and second sprockets are configured and arranged to be radially spaced from and free from contact with the freewheel when the bicycle sprocket assembly is mounted to the freewheel by the freewheel mounting structure.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a side elevational view of a bicycle having a rear wheel with a bicycle sprocket assembly in accordance with a first embodiment of the present invention;

FIG. 2 is an exploded perspective view of the rear wheel of the bicycle showing a freewheel of a hub portion of the rear wheel and various elements of the bicycle sprocket assembly in accordance with a first embodiment of the present invention;

FIG. 3 is a side cross sectional view of the hub portion of the bicycle showing the bicycle sprocket assembly installed on the freewheel, the bicycle sprocket assembly having several chain sprockets, including first, second and third sprockets in accordance with a first embodiment of the present invention;

FIG. 4 is a side elevational view of the first, second and third sprockets shown separated from the bicycle sprocket assembly in accordance with a first embodiment of the present invention;

FIG. 5 is a side elevational view of the first sprocket shown separated from the bicycle sprocket assembly in accordance with a first embodiment of the present invention;

FIG. 6 is a side elevational view of the second sprocket shown separated from the bicycle sprocket assembly in accordance with a first embodiment of the present invention;

FIG. 7 is a side elevational view of the third sprocket shown separated from the bicycle sprocket assembly in accordance with a first embodiment of the present invention;

FIG. 8 is an exploded perspective view of a rear wheel of a bicycle showing a freewheel of a hub portion of the rear wheel and various elements of a bicycle sprocket assembly in accordance with a second embodiment of the present invention;

FIG. 9 is a side elevational view of first, second and third sprockets of the bicycle sprocket assembly depicted in FIG. 8 shown separated from the bicycle sprocket assembly, with the first and second sprockets being constructed from arcuate segments in accordance with the second embodiment of the present invention;

FIG. 10 is a side elevational view of one of the arcuate segments of the first sprocket of the bicycle sprocket assembly depicted in FIG. 8 in accordance with the second embodiment of the present invention;

FIG. 11 is a side elevational view of one of the arcuate segments of the second sprocket of the bicycle sprocket assembly depicted in FIG. 8 in accordance with the second embodiment of the present invention;

FIG. 12 is an exploded perspective view of a rear wheel of a bicycle showing a freewheel of a hub portion of the rear wheel and various elements of a bicycle sprocket assembly in accordance with a third embodiment of the present invention;

FIG. 13 is a cross sectional view of a portion of the first, second and third sprockets of the bicycle sprocket assembly showing connections to the fastening structures in accordance with the third embodiment of the present invention;

FIG. 14 is a side elevational view of first, second and third sprockets of the bicycle sprocket assembly depicted in FIG. 12 shown separated from the bicycle sprocket assembly, with the first and second sprockets being constructed from arcuate segments fixed to one another by fastening structures in accordance with the third embodiment of the present invention;

FIG. 15 is a side elevational view of one of the fastening structures depicted in FIGS. 12 and 13 shown removed from the bicycle sprocket assembly in accordance with the third embodiment of the present invention;

FIG. 16 is a perspective view of one of the fastening structures depicted in FIGS. 12 and 13 shown removed from the bicycle sprocket assembly in accordance with the third embodiment of the present invention;

FIG. 17 is a side elevational view of one of the arcuate segments of the first sprocket of the bicycle sprocket assembly depicted in FIGS. 12 and 13 in accordance with the third embodiment of the present invention;

FIG. 18 is a side elevational view of one of the arcuate segments of the second sprocket of the bicycle sprocket assembly depicted in FIGS. 12 and 13 in accordance with the third embodiment of the present invention;

FIG. 19 is an exploded perspective view of a portion of a rear wheel of a bicycle showing a freewheel of a hub portion of the rear wheel and various elements of a bicycle sprocket assembly in accordance with a fourth embodiment of the present invention;

FIG. 20 is a cross sectional view of the bicycle sprocket assembly depicted in FIG. 19 in accordance with the fourth embodiment of the present invention; and

FIG. 21 is an exploded perspective view of a portion of the bicycle sprocket assembly depicted in FIGS. 19 and 20, showing first, second, third and fourth sprockets of the bicycle sprocket assembly removed from the bicycle sprocket assembly in accordance with the fourth embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

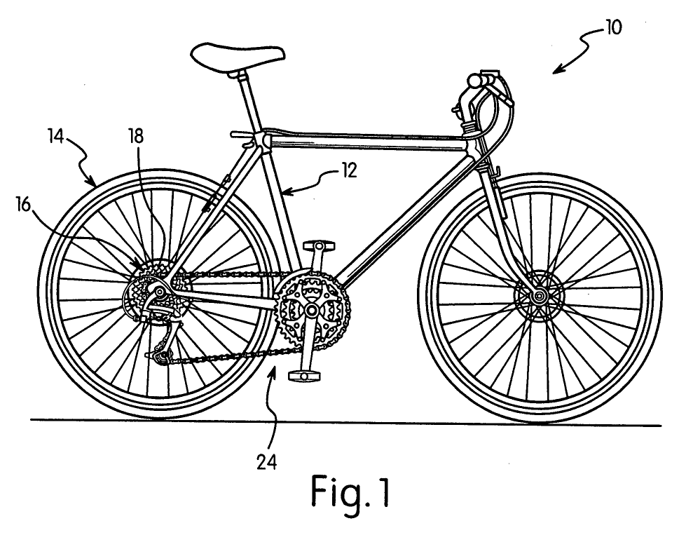

Referring initially to FIG. 1, a bicycle 10 is illustrated in accordance with a first embodiment of the present invention. The bicycle 10 includes a frame 12, rear wheel 14 supported on a rear portion of the frame 12, a hub portion 16, and a sprocket assembly 18 that is mounted to the hub portion 16.

The sprocket assembly 18 includes an increased number of sprockets with weight reduction features in order to minimize overall mass of the sprocket assembly 18.

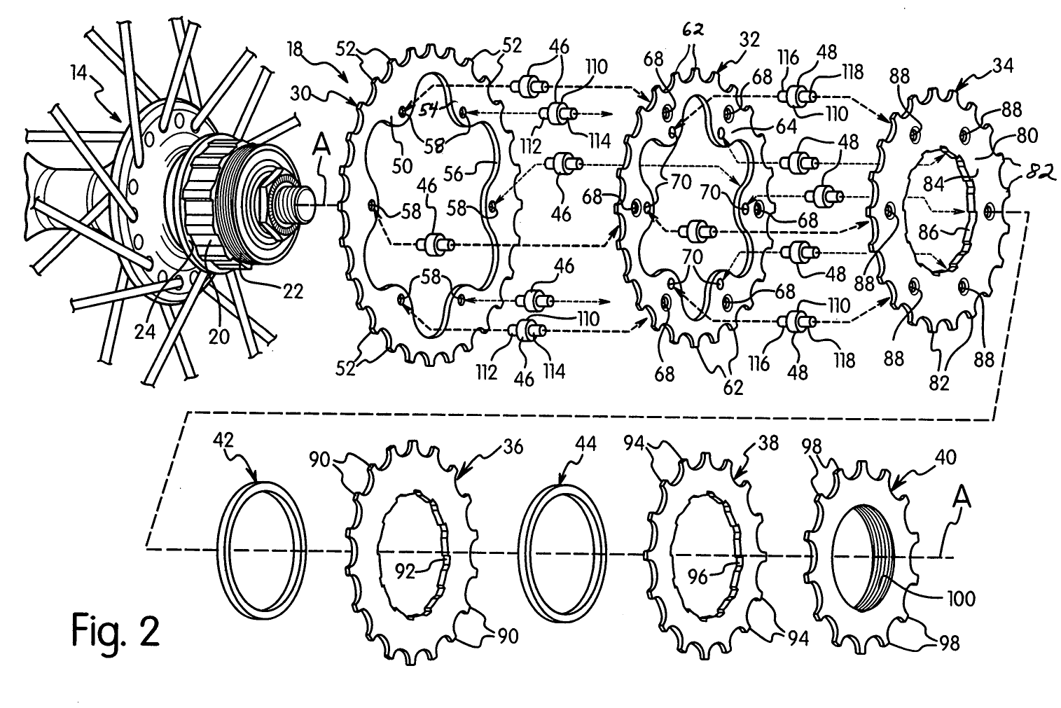

As shown in FIG. 2, the hub portion 16 is located at a central area of the rear wheel 14 and includes a freewheel 20. The freewheel 20 has an outer end with machine threads 22 and at an inner end that includes an annular shoulder 24.

As is also shown in FIG. 2, the sprocket assembly 18 basically includes a first sprocket 30, a second sprocket 32, a third sprocket 34, a fourth sprocket 36, a fifth sprocket 38, a sixth sprocket 40, spacers 42 and 44, fasteners 46 and fasteners 48. The sprocket assembly 18 is configured to rotate about an axis A that extends through the freewheel 20. The first sprocket 30, the second sprocket 32, the third sprocket 34, the fourth sprocket 36, the fifth sprocket 38 and the sixth sprocket 40 are all preferably centered about the axis A.

As shown in FIGS. 2 and 5, the first sprocket 30 is basically an annular ring shaped member that includes a first mounting portion 50 and a first chain engaging portion with first gear teeth 52. The first mounting portion 50 has a first radially innermost end 54 that includes an undulated inner circumferential surface 56. The first mounting portion 50 is provided with a plurality of apertures 58. The apertures 58 are equidistantly spaced apart from one another in a circumferential direction. Further, each aperture 58 is spaced apart from the axis A by a distance D₁. As shown in FIG. 5, six of the apertures 58 are provided in the first sprocket 30. However, this is not a fixed number. Specifically, the first sprocket 30 can be provided with more or less than six of the apertures 58 depending upon design considerations, such as, for example, the size of the first sprocket 30.

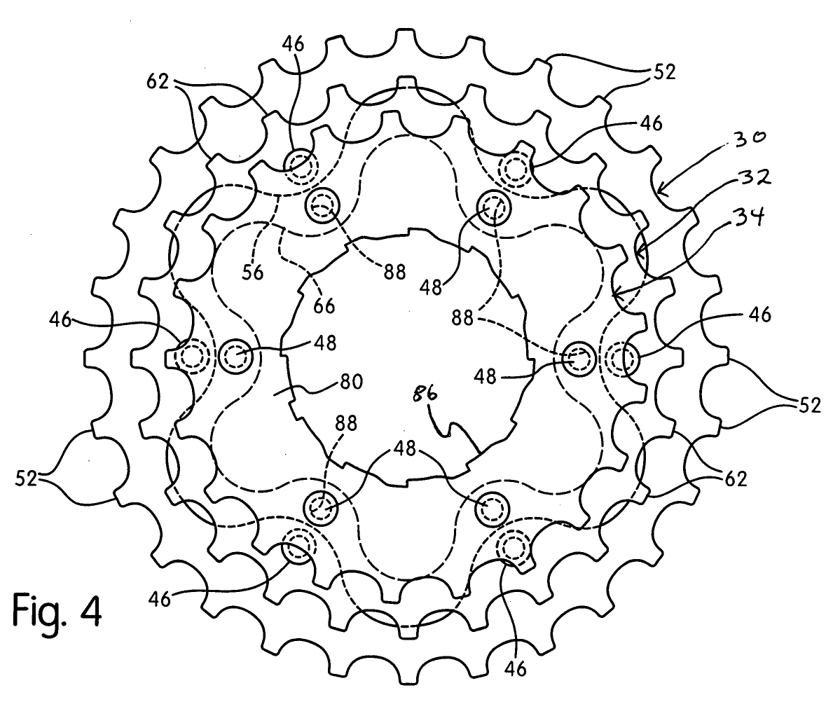

There are 28 of the first gear teeth 52, as shown in FIG. 4. However it should be understood from the description herein that the number of first gear teeth 52 is variable depending upon design criteria, such as, for example, the number of sprockets included in the sprocket assembly 18 and the specific bicycle application of the sprocket assembly 18.

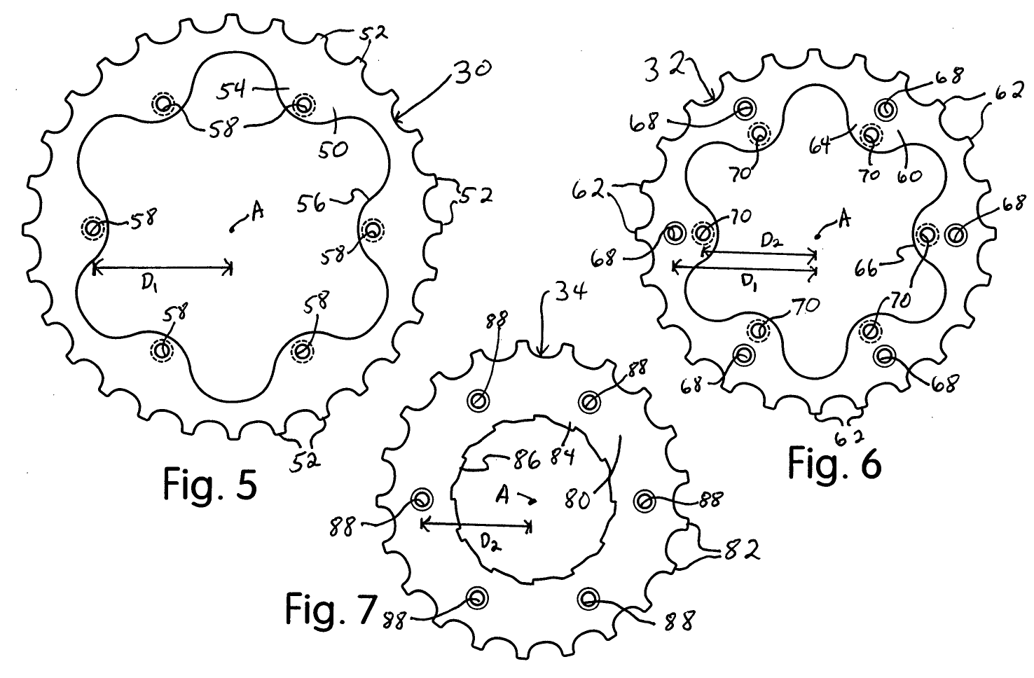

As shown in FIGS. 2 and 6, the second sprocket 32 is also basically an annular ring shaped member that includes a second mounting portion 60 and a second chain engaging portion with second gear teeth 62.

The second mounting portion 60 has a second radially innermost end 64 that includes an undulated inner circumferential surface 66. The second mounting portion 60 is provided with a plurality of first apertures 68 and a plurality of second apertures 70.

The first apertures 68 are equidistantly spaced apart from one another in a circumferential direction in the second mounting portion 60. Each of the first apertures 68 is spaced apart from the axis A by the distance D₁. The second apertures 70 are also equidistantly spaced apart from one another in a circumferential direction in the second mounting portion 60. Each of the apertures 70 is spaced apart from the axis A by a distance D₂. As shown in FIG. 2, the distance D₁ is greater than the distance D₂. Consequently, the apertures 68 are located radially outward from the apertures 70.

As shown in FIG. 6, six of the first apertures 68 and six of the second apertures 70 are provided in the second sprocket 32. However, this is not a fixed number. Specifically, the second sprocket 32 can be provided with more or less than six of the first apertures 68 and more or less than six of the second apertures 70 depending upon design considerations, such as the size of the second sprocket 32.

There are 24 of the second gear teeth 62, as shown in FIG. 4. However it should be understood from the description herein that the number of second gear teeth 62 is variable depending upon design criteria, such as, for example, the number of sprockets included in the sprocket assembly 18 and the specific bicycle application of the sprocket assembly 18. Preferably, the second gear teeth 62 of the second sprocket 32 are fewer in total number than a total number of the first gear teeth 52 of the first sprocket 30.

As shown in FIG. 4, the third sprocket 34 is also basically a one-piece unitary member having an annular ring shape that includes a third mounting portion 80 and a third chain engaging portion with third gear teeth 82. The third mounting portion 80 has a third radially innermost end 84 (an inner edge) that includes an inner circumferential surface 86. The inner circumferential surface 86 includes splines that conform to the outer surface of the freewheel 20 for engagement therewith. The inner circumferential surface 86 therefore defines a freewheel mounting structure configured for engagement with the freewheel 20, the inner circumferential surface 86 being a non-circular opening.

The third mounting portion 80 is provided with a plurality of apertures 88. The apertures 88 are equidistantly spaced apart from one another in a circumferential direction in the third mounting portion 80. Each of the apertures 88 is spaced apart from the axis A by the distance D₂. The apertures 88 are also equidistantly spaced apart from one another in a circumferential direction in the third mounting portion 80.

As shown in FIG. 4, six of the apertures 88 are provided in the third sprocket 34. However, this is not a fixed number. Specifically, the third sprocket 34 can be provided with more or less than six of the apertures 88 depending upon design considerations, such as the size of the third sprocket 34.

There are 21 of the third gear teeth 82, as shown in FIG. 4. However it should be understood from the description herein that the number of third gear teeth 82 is variable depending upon design criteria, such as, for example, the number of sprockets included in the sprocket assembly 18 and the specific bicycle application of the sprocket assembly 18. Preferably, the third gear teeth 82 of the third sprocket 34 are fewer in total number than a total number of the second gear teeth 62 of the second sprocket 32.

As shown in FIG. 2, the fourth sprocket 36 includes fourth gear teeth 90 and a radially innermost end that includes an inner circumferential surface 92. The inner circumferential surface 92 includes splines that conform to the outer surface of the freewheel 20 for engagement therewith. Preferably, the number of the fourth gear teeth 90 is less than the number of third gear teeth 82.

As shown in FIG. 2, the fifth sprocket 38 includes fifth gear teeth 94 and a radially innermost end that includes an inner circumferential surface 96. The inner circumferential surface 96 includes splines that conform to the outer surface of the freewheel 20 for engagement therewith. Preferably, the number of the fifth gear teeth 94 is less than the number of fourth gear teeth 90.

As shown in FIG. 2, the sixth sprocket 40 includes sixth gear teeth 98 and a radially innermost end that includes an inner circumferential surface 100. Preferably, the number of the sixth gear teeth 98 is less than the number of fifth gear teeth 94. The inner circumferential surface 100 includes machine threads configured and dimensioned to screw on to the machine threads 22 of the freewheel 20.

As shown in FIG. 2, the spacers 42 and 44 are both ring shaped members having generally the same dimensions.

As shown in FIG. 2, the fasteners 46 and 48 have generally the same dimensions and features, and are circumferentially spaced apart from one another. The fasteners 46 and 48 define individual fastening structures. The fasteners 46 include a spacer body 110, a first connection end 112 and a second connection end 114. The spacer body 110 has a first diameter that is greater than the diameter of either of the first and second connection ends 112 and 114. In other words, the diameters of the first and second connection ends 112 and 114 are smaller that the diameter of the spacer body 110. Similarly, the fasteners 48 also have the spacer body 110, a first connection end 116 and a second connection end 118. As with the fasteners 46, the spacer body 110 of the fasteners 48 has a first diameter that is greater than the diameter of either of the first and second connection ends 116 and 118.

Further in an uninstalled condition, the diameters of the first connection ends 112 and 114, and 116 and 118 are dimensioned to fit into the apertures 58 and 68, and 70 and 88 respectively. Specifically, the first connection end 112 of each of the fasteners 46 is fitted into a respective one of the apertures 58 of the first sprocket 30. The second connection end 114 of each of the fasteners 46 is fitted into a respective one of the apertures 68 of the second sprocket 32. Further, the first connection end 116 of each of the fasteners 48 is fitted into a respective one of the apertures 70 of the second sprocket 32, and the second connection end 118 of each of the fasteners 48 is fitted into a respective one of the apertures 88 of the third sprocket 34.

As mentioned above, the fasteners 46 and 48 are individual fastening structures. As such, the fasteners 46 define a first set of fasteners and the fasteners 48 define a second set of fasteners, with the first set of fasteners being disposed between the first and second sprockets 30 and 32, the second set of fasteners being disposed between the second and third sprockets 32 and 34.

Once the fasteners 46 are installed in the first and second sprockets 30 and 32, the first and second connection ends 112 and 114 are crimped or deformed or other wise secured thereby fixedly attaching the first sprocket 30 to the second sprocket 32 in a spaced apart relationship due to the spacer body 110. Further, once the fasteners 48 are installed in the second and third sprockets 32 and 34, the first and second connection ends 116 and 118 are crimped or deformed or other wise secured thereby fixedly attaching the second sprocket 32 to the third sprocket 34 in a spaced apart relationship due to the spacer body 110. Hence, the first mounting portion 50 of the first sprocket 30 is directly connected to the second mounting portion 60 of the second sprocket 32 by the first fasteners 46 at a plurality of circumferentially spaced apart locations such that the first sprocket 30 is supported on the second sprocket 32 by the fasteners 46 and axially spaced from the second sprocket 32 by the fasteners 46.

Similarly, the second mounting portion 60 of the second sprocket 32 is directly connected to the third mounting portion 80 of the third sprocket 34 by the second fasteners 48 such that the second sprocket 32 is supported on the third sprocket 34 by the fasteners 48 and axially spaced from the third sprocket 34 by the fasteners 48.

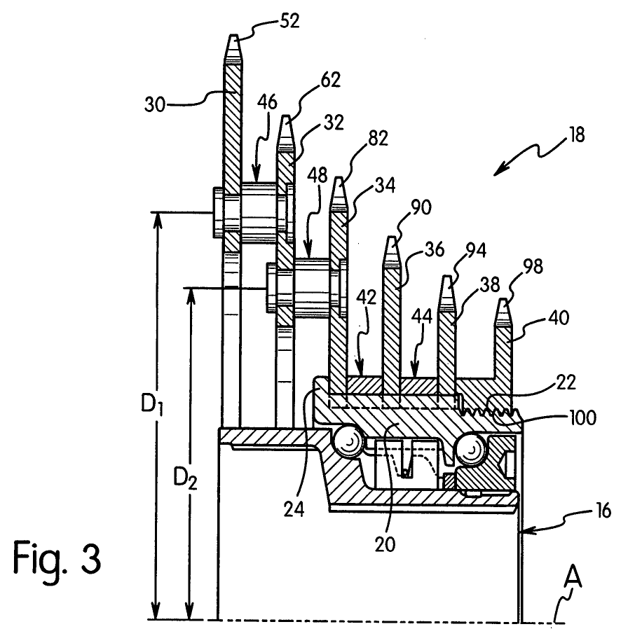

As shown in FIG. 4, the first, second and third sprockets 30, 32 and 34 form a sprocket sub-assembly that is installed on the freewheel 20 as a unit with only the third sprocket 32 directly contacting the freewheel 20. With the configuration described above, the third radially innermost end 84 of the third sprocket 34, which includes the inner circumferential surface 86 (a freewheel mounting structure), is configured to be mounted to the freewheel 20, as shown in FIG. 3. Further, the first and second radially innermost ends 54 and 64 of the first and second sprockets 30 and 32, respectively, are configured and arranged to be radially spaced from and free from contact with the freewheel 20 when the sprocket assembly 18 is mounted to the freewheel 20.

Since the first and second sprockets 30 and 32 are formed with their respective undulated inner circumferential surfaces 56 and 66, the mass of the first and second sprockets 30 and 32 is reduced. Further, since the first and second sprockets 30 and 32 are spaced apart from the freewheel 20 and are supported on the freewheel 20 via connection to the third sprocket 34, further weight reduction is achieved.

### Second Embodiment

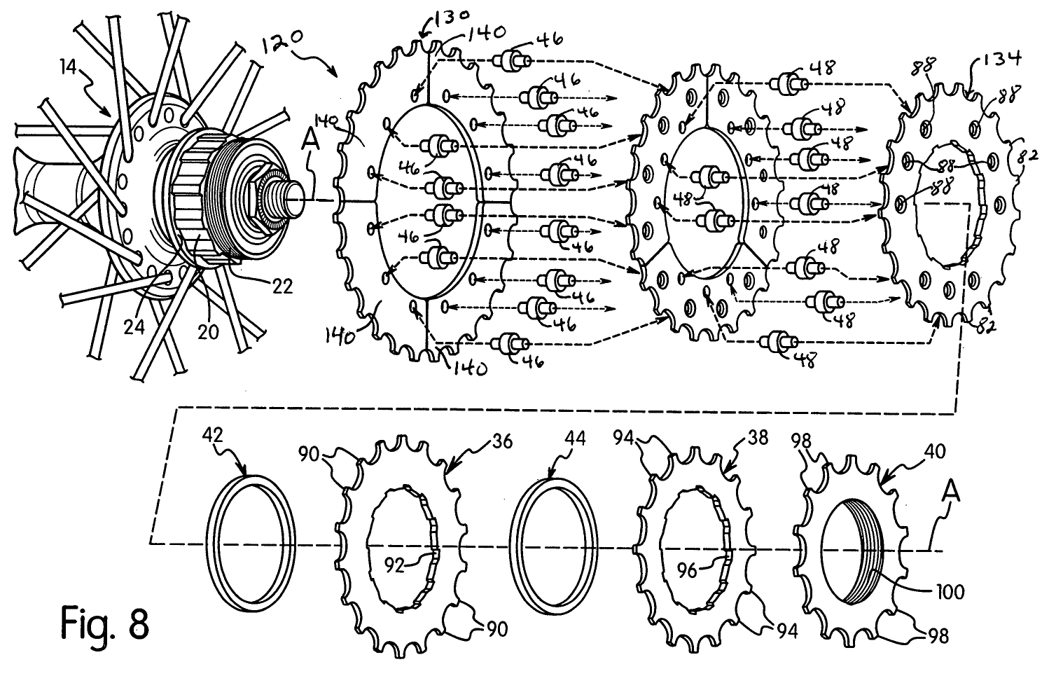

Referring now to FIG. 8-11, a sprocket assembly 120 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

As shown in FIG. 8, the sprocket assembly 120 has many elements that are identical to those of the first embodiment. For example, the rear wheel 14 and freewheel 20 are the same as in the first embodiment. Further, the fourth sprocket 36, the fifth sprocket 38, the sixth sprocket 40 and the spacers 42 and 44 are identical to those described above in the first embodiment. The fasteners 46 and 48 are also identical to those of the first embodiment, except that the number of the fasteners 46 and 48 used in the second embodiment is increased in the second embodiment.

In the second embodiment, the first, second and third sprockets 30, 32 and 34 have been replaced with a first sprocket assembly 130, a second sprocket assembly 132 and a third sprocket 134.

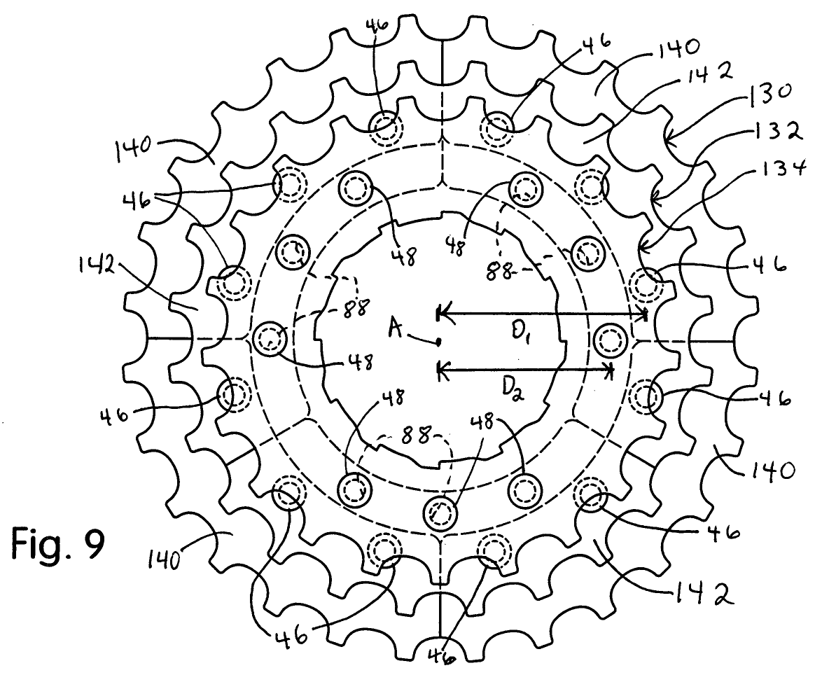

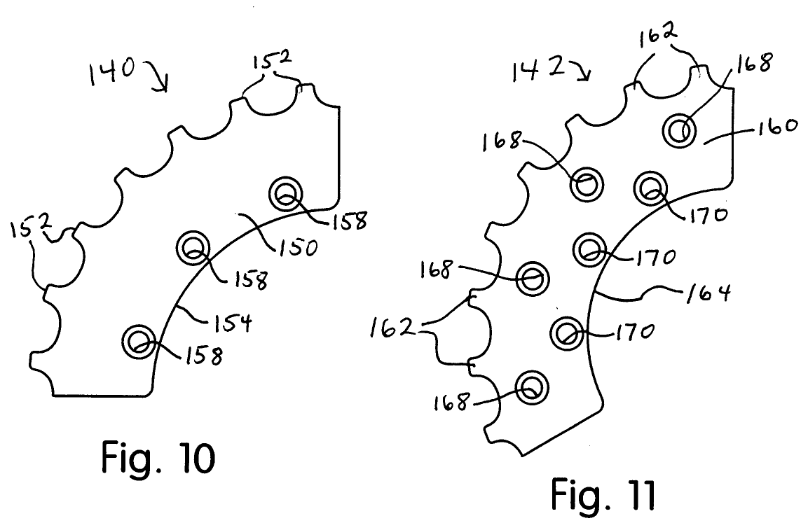

As shown in FIG. 8, the first sprocket assembly 130 is an annular ring shaped member that is made up of four arcuate shaped sprocket segments 140. Each of the sprocket segments 140 arcs approximately 90 degrees with the axis A as a center point. As shown in FIG. 10, each of the sprocket segments 140 includes a first mounting portion 150 and a first chain engaging portion with first gear teeth 152. The first mounting portion 150 has a first radially innermost end 154. The first radially innermost end 154 is depicted with an arcuate surface, but can alternatively include an undulated inner circumferential surface similar to the undulated inner circumferential surface 56 of the first embodiment. The first mounting portion 150 is provided with a plurality of apertures 158. The apertures 158 are equidistantly spaced apart from one another in a circumferential direction. Further, each aperture 158 is spaced apart from the axis A by the distance D₁. As shown in FIGS. 9 and 10, each of the sprocket segments 140 includes three of the apertures 158. Therefore, there are a total of twelve apertures 158 provided in the first sprocket assembly 130. However, this is not a fixed number. Specifically, the first sprocket assembly 130 can be provided with more or less than the number of apertures 158 shown, depending upon design considerations, such as, for example, the size of the first sprocket assembly 130.

There are seven of the first gear teeth 152 on each sprocket segment 140, providing the first sprocket assembly 130 with a total of twenty-eight first gear teeth 152, as shown in FIGS. 8 and 9. However it should be understood from the description herein that the number of first gear teeth 152 is variable depending upon design criteria, such as, for example, the number of sprockets included in the sprocket assembly 120 and the specific bicycle application of the sprocket assembly 120.

As shown in FIG. 8, the second sprocket assembly 132 is also basically an annular ring shaped member that is made up of three arcuate shaped sprocket segments 142. Each of the sprocket segments 142 arcs approximately 120 degrees with the axis A as a center point. Each of the sprocket segments 142 includes a second mounting portion 160 and a second chain engaging portion with second gear teeth 162. The second mounting portion 160 has a second radially innermost end 164 is depicted with an arcuate surface, but can alternatively include an undulated inner circumferential surface similar to the undulated inner circumferential surface 66 of the first embodiment. The second mounting portion 160 is provided with a plurality of first apertures 168 and a plurality of second apertures 170.

The first apertures 168 are equidistantly spaced apart from one another in a circumferential direction in the second mounting portion 160. Each of the first apertures 168 is spaced apart from the axis A by the distance D₁ as shown in FIG. 9. The second apertures 170 are also equidistantly spaced apart from one another in a circumferential direction in the second mounting portion 160.

Each of the apertures 170 is spaced apart from the axis A by a distance D₂. As with the first embodiment, the distance D₁ is greater than the distance D₂. Consequently, the apertures 168 are located radially outward from the apertures 170.

As shown in FIGS. 8, 9 and 11, there are four of the first apertures 168 and three of the second apertures 170 are provided in each of the sprocket segments 140. Therefore, the second sprocket assembly 132 includes twelve first apertures 168 and nine of the second apertures 170. However, this is not a fixed number. Specifically, the second sprocket assembly 132 can be provided with more or less of the first apertures-168 and more or less of the second apertures 170 depending upon design considerations, such as the size of the second sprocket assembly 132.

There are 24 of the second gear teeth 162, as shown in FIGS. 8 and 9. However it should be understood from the description herein that the number of second gear teeth 162 is variable depending upon design criteria, such as, for example, the number of sprockets included in the sprocket assembly 120 and the specific bicycle application of the sprocket assembly 120. Regardless, the second gear teeth 162 of the second sprocket assembly 132 are fewer in total number than a total number of the first gear teeth 152 of the first sprocket assembly 130.

As shown in FIG. 9, the third sprocket 134 is an annular ring shaped member identical to the third sprocket 34 of the first embodiment, except that the number of apertures 88 is increased from six to nine. Each of the apertures 88 is spaced apart from the axis A by the distance D₂. The apertures 88 are circumferentially spaced apart to be in alignment with the apertures 170 in the sprocket segments 142.

The fasteners 46 fix the first and second sprocket assemblies 130 and 132 together, and the fasteners 48 fix the second sprocket assembly 132 to the third sprocket 134. Specifically, first ends of the fasteners 46 are fitted into the apertures 158 of the sprocket segments 140 of the first sprocket assembly 130 and the second ends of the fasteners 46 are fitted into the apertures 168 of the sprocket segments 142 of the second sprocket assembly 132. The first end of the fasteners 48 are fitted into the apertures 170 of the sprocket segments 142 and the second ends of the fasteners 48 are fitted into the apertures 88 of the third sprocket 134. Consequently, the third sprocket 134 is fitted onto the freewheel 20 thereby supporting the first and second sprocket assemblies 130 and 132. The first and second sprocket assemblies 130 and 132 are spaced apart from the freewheel 20 and do not directly contact the freewheel 20. Since the first and second sprocket assemblies 130 and 132 are made of small arcuate sprocket segments 140 and 142, the number of sprockets is increased without a significant increase in overall weight of the sprocket assembly 120.

It should be understood from the drawings and the description herein that the number of sprocket segments 140 and sprocket segments 142 is not limited to the number described above. Further, the arcuate length of the sprocket segments 140 and sprocket segments 142 is variable between at least a 45 degree arcuate length (with the axis A as a center point) to an arcuate length of 180 degrees.

### Third Embodiment

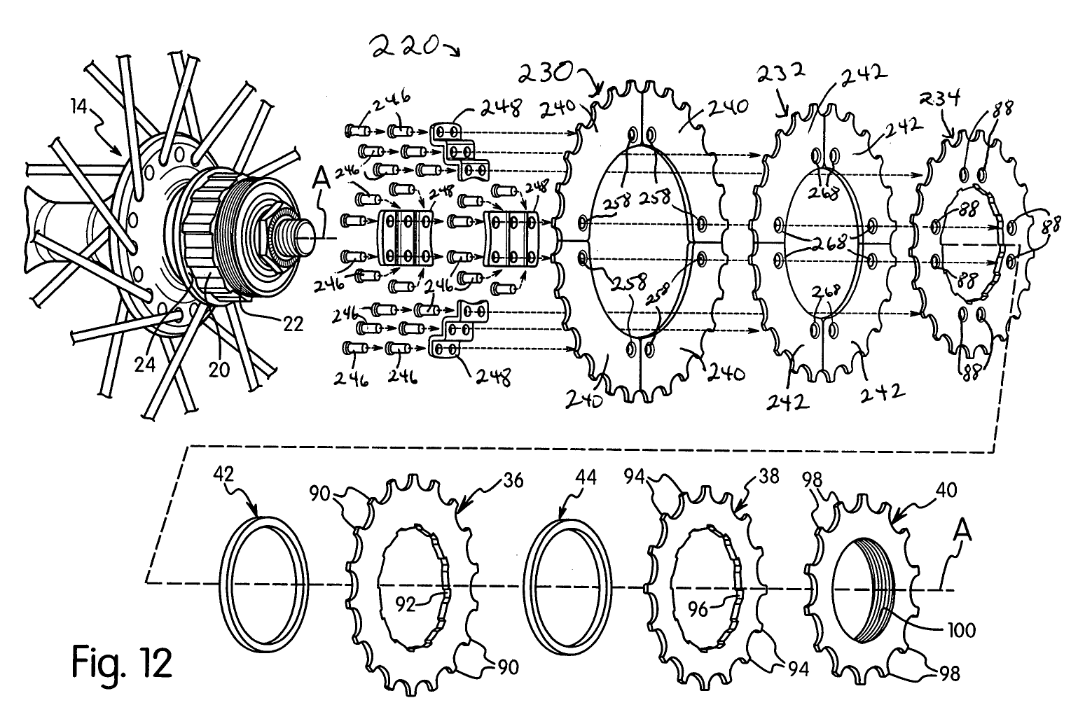

Referring now to FIG. 12-18, a sprocket assembly 220 in accordance with a third embodiment will now be explained. In view of the similarity between the third embodiment and the prior embodiments, the parts of the third embodiment that are identical to the parts of the prior embodiments will be given the same reference numerals as the parts of the prior embodiments. Moreover, the descriptions of the parts of the third embodiment that are identical to the parts of the prior embodiments may be omitted for the sake of brevity.

As shown in FIG. 12, the sprocket assembly 220 has many elements that are identical to those of the first embodiment. For example, the rear wheel 14 and freewheel 20 are the same as in the first embodiment. Further, the fourth sprocket 36, the fifth sprocket 38, the sixth sprocket 40 and the spacers 42 and 44 are identical to those described above in the first embodiment. However, the first, second and third sprockets 30, 32 and 34 of the first embodiment have been replaced with a first sprocket assembly 230, a second sprocket assembly 232 and a third sprocket 234. Further, the fasteners 46 and 48 have been replaced with fasteners 246 and fastening structures 248.

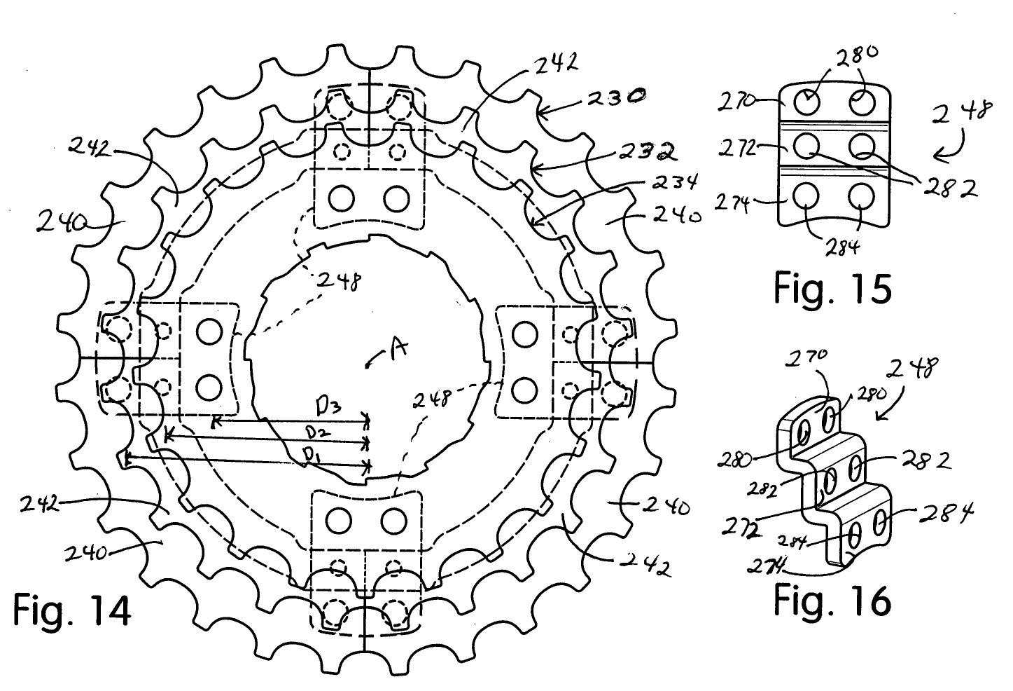

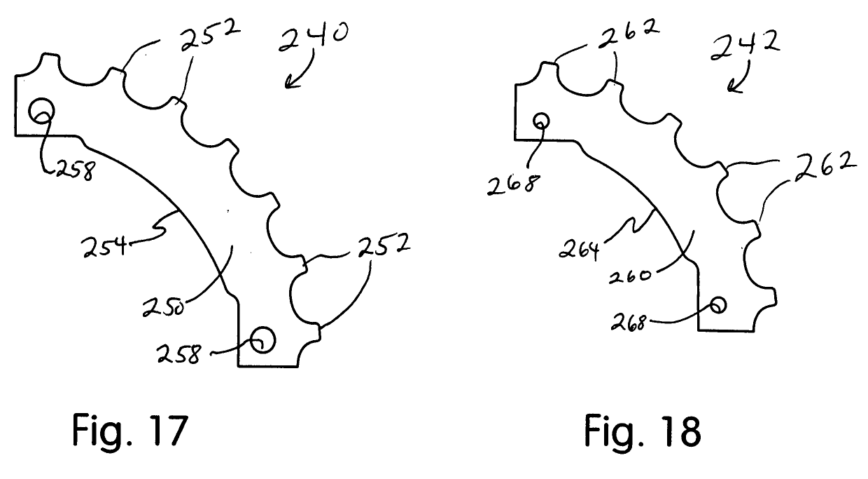

As shown in FIGS. 12 and 14, the first sprocket assembly 230 is an annular ring shaped member that is made up of four arcuate shaped sprocket segments 240. Each of the sprocket segments 240 arcs approximately 90 degrees with the axis A as a center point. As shown in FIG. 17, each of the sprocket segments 240 includes a first mounting portion 250 and a chain engaging portion with first gear teeth 252. The first mounting portion 250 has a first radially innermost end 254. The first radially innermost end 254 is depicted with an arcuate surface, but can alternatively include an undulated inner circumferential surface similar to the undulated inner circumferential surface 56 of the first embodiment. The first mounting portion 250 is provided with a plurality of apertures 258. As shown in FIG. 14, each aperture 258 is spaced apart from the axis A by the distance D₁. As shown in FIGS. 12, 14 and 17, each of the sprocket segments 240 includes two of the apertures 258. Therefore, there are a total of eight apertures 258 provided in the first sprocket assembly 230.

As shown in FIG. 17, there are seven of the first gear teeth 252 on each sprocket segment 240, providing the first sprocket assembly 230 with a total of twenty-eight first gear teeth 252, as shown in FIG. 14.

As shown in FIGS. 12 and 14, the second sprocket assembly 232 is also basically an annular ring shaped member that is made up of four arcuate shaped sprocket segments 242. Each of the sprocket segments 242 arcs approximately 90 degrees with the axis A as a center point. Each of the sprocket segments 242 includes a second mounting portion 260 and a second chain engaging portion with second gear teeth 262. The second mounting portion 260 has a second radially innermost end 264 is depicted with an arcuate surface, but can alternatively include an undulated inner circumferential surface similar to the undulated inner circumferential surface 66 of the first embodiment. The second mounting portion 260 is provided with a plurality of apertures 268.

Each of the apertures 268 is spaced apart from the axis A by the distance D₂ as shown in FIG. 14. As with the first embodiment, the distance D₁ is greater than the distance D₂.

As shown in FIGS. 12 and 14, the third sprocket 234 is an annular ring shaped member identical to the third sprocket 34 of the first embodiment, except that the number of apertures 88 is increased from six to eight. Each of the apertures 88 is spaced apart from the axis A by the distance D₃.

There are four of the fastening structures 248 in the third embodiment. However, it should be understood from the description herein and the drawings that the number of fastening structures 248 can be modified depending upon the arcuate length of the sprocket segments 240 and 242. The description below is directed to only one of the fastening structures 248 to provide brevity. Specifically, the description of one fastening structure 248 applies to all four.

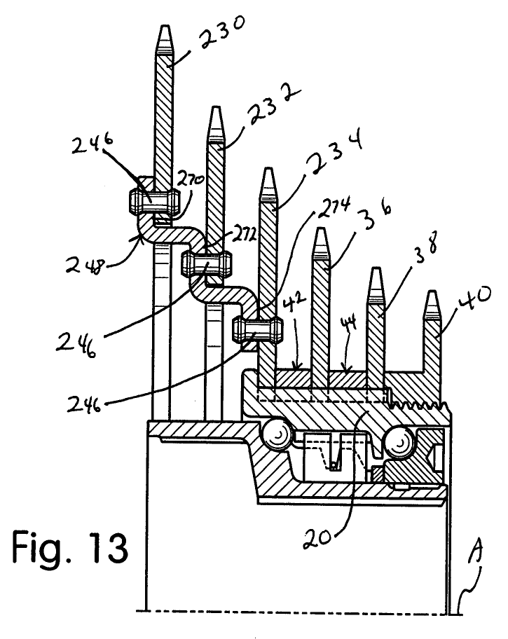

As best shown in FIGS. 13 and 16, each of the fastening structures 248 includes a first stepped surface 270, a second stepped surface 272 and a third stepped surface 274 that are spaced apart from one another. The first stepped surface 270 is configured to connect to corresponding ones of the first mounting portions 250 of the sprocket segments 240 of the first sprocket assembly 230. The second stepped surface 272 is configured to connect to corresponding ones of the second mounting portion 260 of the second sprocket assembly 232. The third stepped surface 274 is configured to connect to corresponding ones of the third mounting portions of the third sprocket 234 such that the first and second sprocket assemblies 230 and 232 and third sprocket 234 are axially spaced apart from one another. Specifically, the first stepped surface 270, the second stepped surface 272 and the third stepped surface 274 are spaced apart from one another in order to provide the desired spacing.

The first stepped surface 270 includes a pair of apertures 280, the second stepped surface 272 includes a pair of apertures 282 and the third stepped surface 274 includes a pair of apertures 284. The sprocket segments 240 of the first sprocket assembly 230 are fixed to the first stepped surface 270 by a corresponding number of the fasteners 246 that extend through the apertures 258 and the apertures 280. The sprocket segments 242 of the second sprocket assembly 232 are fixed to the second stepped surface 272 by a corresponding number of the fasteners 246 that extend through the apertures 268 and the apertures 282. The third sprocket 234 is fixed to the third stepped surface 274 by a corresponding number of fasteners 246 that extend through the apertures 284 and the apertures 88.

It should be understood from the drawings and the description herein that the number of the sprocket segments 240, the sprocket segments 242 and the fastening structures 248 is not limited to the number described above. Specifically, a greater number or a lesser number of each of the sprocket segments 240, the sprocket segments 242 and the fastening structures 248 is possible depending upon a variety of design considerations, such as, for example, the size of the respective sprockets in the sprocket assembly.

### Fourth Embodiment

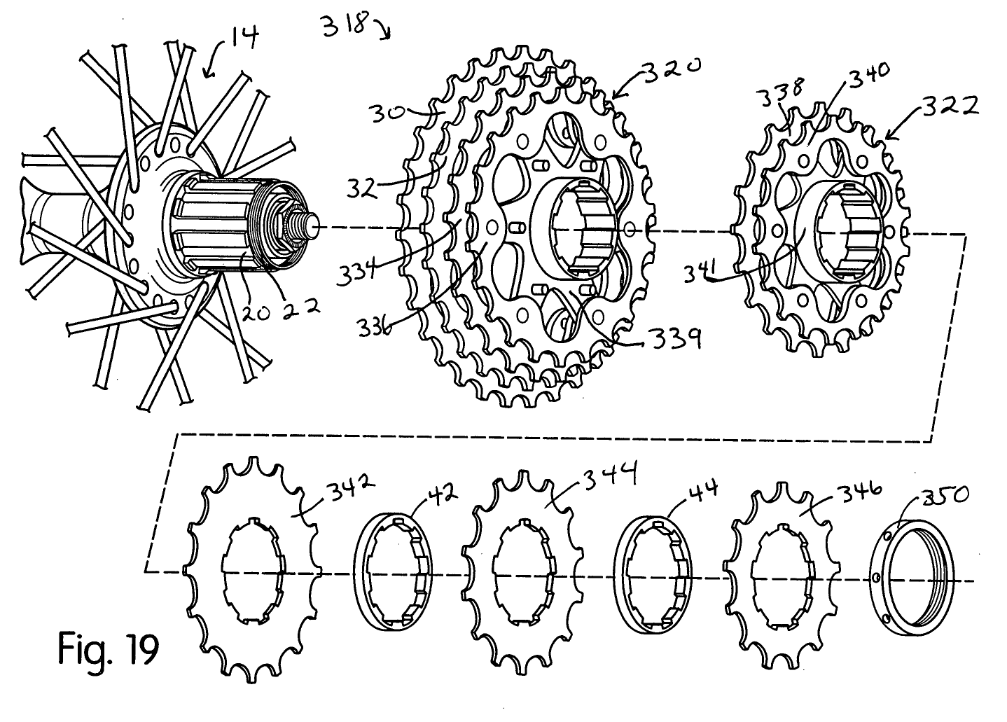

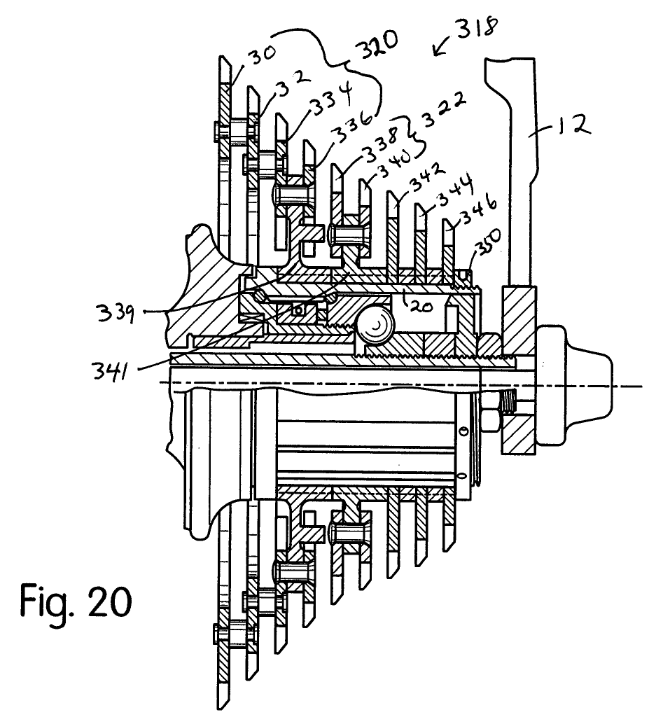

Referring now to FIGS. 19, 20 and 21, a sprocket assembly 318 in accordance with a fourth embodiment will now be explained. In view of the similarity between the fourth embodiment and the prior embodiments, the parts of the fourth embodiment that are identical to the parts of the prior embodiments will be given the same reference numerals as the parts of the prior embodiments. Moreover, the descriptions of the parts of the fourth embodiment that are identical to the parts of the prior embodiments may be omitted for the sake of brevity.

The sprocket assembly 318 basically includes: a first sub-assembly 320 that includes the first sprocket 30, the second sprocket 32, a third sprocket 334, a fourth sprocket 336 and a carrier 339; a second sub-assembly 322 that includes fifth and sixth sprockets 338 and 340 and a carrier 341; and seventh eighth and ninth sprockets 342, 344 and 346. The sprocket assembly 318 further includes spacers 42 and 44 and a locking ring 350.

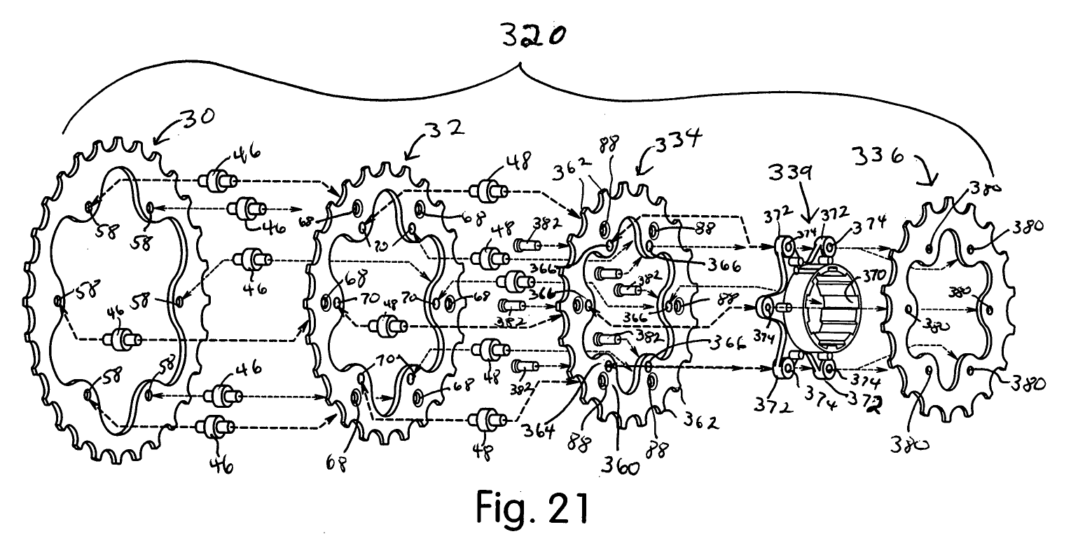

A description of the first sub-assembly 320 is provided with specific reference to FIG. 21. The first sprocket 30 and the second sprocket 32 are identical to the first sprocket 30 described above in the first embodiment.

The third sprocket 334 is basically an annular ring shaped member that includes a mounting portion 360 and a third chain engaging portion with third gear teeth 362. The third mounting portion 360 has a third radially innermost end 364 that includes an undulated inner circumferential surface that provides weight reduction. The third mounting portion 360 is provided with a plurality of the apertures 88 (as in the first embodiment) and a plurality of apertures 366 that are positioned radially inward from the apertures 88. The apertures 366 are equidistantly spaced apart from one another in a circumferential direction.

The carrier 339 (a spider) is an annular member that includes an inner surface 370 (a freewheel mounting structure) configured to engage a freewheel 371, and a plurality of radially extending legs 372. Each leg 372 includes an aperture 374. The apertures 374 are dimensioned to align with the apertures 366.

The fourth sprocket 336 includes an undulated inner circumferential surface that provides weight reduction and a plurality of apertures 380.

The first sprocket 30, the second sprocket 32 and the third sprocket 334 are fixed to one another by the fasteners 46 and 48 in the manner described above in the first embodiment with reference to the connections between the first sprocket 30, the second sprocket 32 and the third sprocket 34. However, in the fourth embodiment, the fasteners 382 extend through the apertures 366 in the third sprocket 334, through the apertures 374 in the carrier 339 and through the apertures 380 in the fourth sprocket 336 thereby making the first sub-assembly 320.

The second sub-assembly 322 is a conventional assembly with the fifth and sixth sprockets 338 and 340 fixed to the carrier 341.

The sprocket assembly 318 is retained on the freewheel 371 by the locking ring 350.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. As used herein to describe the present invention, the following directional terms “forward, rearward, above, downward, vertical, horizontal, below and transverse” as well as any other similar directional terms refer to those directions of a bicycle equipped with the present invention. Accordingly, these terms, as utilized to describe the present invention should be interpreted relative to a bicycle equipped with the present invention as used in the normal riding position. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A bicycle sprocket assembly comprising:
a first sprocket including a first mounting portion with a first radially innermost end, and a first chain engaging portion with a plurality of first teeth;
a second sprocket including a second mounting portion with a second radially innermost end, and a second chain engaging portion with a plurality of second teeth, the first mounting portion of the first sprocket being directly connected to the second mounting portion of the second sprocket by a plurality of individual first fasteners at a plurality of circumferentially spaced apart locations such that the first sprocket is supported on the second sprocket by the first fasteners and axially spaced from the second sprocket by the first fasteners; and
a third sprocket including a third mounting portion with a third radially innermost end, and a third chain engaging portion with a plurality of third teeth, the second mounting portion of the second sprocket being directly connected to the third mounting portion of the third sprocket by a plurality of individual second fasteners such that the second sprocket is supported on the third sprocket by the second fasteners and axially spaced from the third sprocket by the second fasteners,
the third radially innermost end of the third sprocket including a freewheel mounting structure configured to be mounted to a freewheel, the first and second radially innermost ends of the first and second sprockets being configured and arranged to be radially spaced from and free from contact with the freewheel when the bicycle sprocket assembly is mounted to the freewheel by the freewheel mounting structure.

2. The bicycle sprocket assembly according to claim 1, wherein
the second teeth of the second sprocket are fewer in total number than a total number of the first teeth of the first sprocket, the third teeth of the third sprocket are fewer in total number than a total number of the second teeth of the second sprocket.

3. The bicycle sprocket assembly according to claim 1, wherein
the third sprocket is a one-piece, unitary member with the freewheel mounting structure being a non-circular opening that defines an inner edge of the third sprocket.

4. The bicycle sprocket assembly according to claim 1, wherein
the third sprocket includes a gear portion having the third chain engaging portion and a carrier having the freewheel mounting structure.

5. The bicycle sprocket assembly according to claim 1, wherein
the first radially innermost end of the first sprocket includes an undulated inner circumferential surface.

6. The bicycle sprocket assembly according to claim 1, wherein
the second radially innermost end of the second sprocket includes an undulated inner circumferential surface.

7. The bicycle sprocket assembly according to claim 1, wherein
at least one of the first and second sprockets comprises a plurality of arcuate shaped segments.

8. The bicycle sprocket assembly according to claim 7, wherein
the arcuate shaped segments comprise at least a 45 degree segment of the one of the first and second sprockets.

9. The bicycle sprocket assembly according to claim 1, wherein
each the individual first fasteners and the individual second fasteners includes a first attachment end, a central spacer portion and a second attachment end, the central spacer portion having an outer diameter greater than an outer diameter of either of the first and second attachment ends.

10. A bicycle sprocket assembly comprising:
a first sprocket including a first mounting portion with a first radially innermost end, and a first chain engaging portion with a plurality of first teeth;
a second sprocket including a second mounting portion with a second radially innermost end, and a second chain engaging portion with a plurality of second teeth that are fewer in total number than a total number of the first teeth of the first sprocket;
a third sprocket being a one-piece, unitary member including a third mounting portion with a third radially innermost end having a non-circular torque transmitting opening that defines an inner edge of the third sprocket configured to be mounted to a freewheel to transmit torque, and a third chain engaging portion with a plurality of third teeth that are fewer in total number than a total number of the second teeth of the second sprocket; and
a plurality of individual fastening structures coupling the first, second and third sprockets together at circumferentially spaced apart locations, the individual fastening structures providing axial spacing between each of the first, second and third sprockets,
the first and second radially innermost ends of the first and second sprockets being configured and arranged to be radially spaced from and free from contact with the freewheel when the bicycle sprocket assembly is mounted to the freewheel by the inner edge of the third sprocket.

11. The bicycle sprocket assembly according to claim 10, wherein
the first radially innermost end of the first sprocket includes an undulated inner circumferential surface.

12. The bicycle sprocket assembly according to claim 10, wherein
the second radially innermost end of the second sprocket includes an undulated inner circumferential surface.

13. The bicycle sprocket assembly according to claim 10, wherein
at least one of the first and second sprockets comprises a plurality of arcuate shaped segments.

14. The bicycle sprocket assembly according to claim 13, wherein
the arcuate shaped segments comprise at least a 45 degree segment of the one of the first and second sprockets.

15. The bicycle sprocket assembly according to claim 10, wherein
each of the individual fastening structures are circumferentially spaced apart from one another.

16. The bicycle sprocket assembly according to claim 15, wherein
each of the individual fastening structures includes first, second and third stepped surfaces that are spaced apart from one another, the first stepped surface configured to connect to the first mounting portion of the first sprocket, the second stepped surface configured to connect to the second mounting portion of the second sprocket and the third stepped surface configured to connect to the third mounting portion of the third sprocket such that the first, second and third sprockets are axially spaced apart from one another.

17. The bicycle sprocket assembly according to claim 10, wherein
the individual fastening structures comprise a first set of fasteners and a second set of fasteners, the first set of fasteners disposed between the first and second sprockets, the second set of fasteners disposed between the second and third sprockets.

18. The bicycle sprocket assembly according to claim 17, wherein
each of plurality of individual fastening structures include a first attachment end, a central spacer portion and a second attachment end, the central spacer portion having an outer diameter greater than an outer diameter of either of the first and second attachment ends.

19. The bicycle sprocket assembly according to claim 10, wherein
each of plurality of individual fastening structures include a first attachment end, a central spacer portion and a second attachment end, the central spacer portion having an outer diameter greater than an outer diameter of either of the first and second attachment ends.
